(19) United States
(12) Patent Application Publication
(10) Pub. No.: US 2006/0210377 A1
(43) Pub. Date: Sep. 21, 2006

(54) Method of producing a folded, closed booklet which is glued at the central fold therof

(76) Inventor: Jean-Marc Rondeau, La Queue En Brie (FR)

Correspondence Address: BLAKELY SOKOLOFF TAYLOR & ZAFMAN/PDC, 12400 WILSHIRE BOULEVARD, SEVENTH FLOOR, LOS ANGELES, CA, 90025, US

(21) Appl. No.: 10/549,263

(22) PCT Filed: Mar. 3, 2004
(86) PCT No.: PCT/FR04/00490

§ 371 Date: Sep. 12, 2005

(30) Foreign Application Priority Data
Mar. 13, 2003 (FR) 0303088

(51) Int. Cl. B42C 9/00

(52) U.S. Cl. 412/1

(57) ABSTRACT

The invention relates to a method of producing a folded, closed booklet which is glued at the central fold thereof. The invention is characterised in that several identical sheets of paper having the same format are stacked on top of one another and are interconnected using a seam of glue which is applied transversely along the centre thereof, and all of said sheets are subsequently folded. The aforementioned glue seam forms a central hinge (1) around which the symmetric pages (2) are articulated. Each of the pages comprises a fold line (3) along the centre thereof, thereby defining an end panel (4a) and a central panel (4b). The inner faces of all of the stacked end panels (4a) are then folded simultaneously against the inner faces of all of the stacked central panels (4b), by means of folding in quires, such that the inner faces of the end panels (4a) are pressed against the inner faces of the central panels (4b) which are articulated around the above-mentioned central hinge (1). Glue is applied to two faces of the booklet, in the form of a line along the edge or drops at suitable points, and the inner faces of the booklet are then applied against one another in order to close same.

### 1. THE AREA RELATING TO THE INVENTION

This present invention concerns a method of producing a booklet that is glued at the central fold, whose sheets are folded and then pressed together to be finally closed by gluing.

The resulting booklet is intended in particular, in a non-limited application, to be used as an information medium, an explanatory booklet, or a presentation document of product ranges.

### 2. PRE-EXISTING METHODS

Booklets used for these purposes are already well known. They accompany all sorts of products and appliances in order to provide the consumer and user with information of a commercial or technical nature. The main drawback of these media concerns their awkward handling properties, so that reading them is rendered difficult after they have been unfolded.

According to a known method used for their preparation, when the sheets of these booklets have been folded into concertina form, unfolding them gives a voluminous and formless quality to the booklet which renders it inconvenient to handle and to read. This is also the case when the booklet, whose sheets are folded, is enclosed by an off-centre end-sheet that is folded onto the other folded sheets, so that this cover sheet makes handling the booklet awkward when it has been opened.

Also coming onto the market are small-format information media, frequently inserted between the pages of magazines and affixed to one of the pages by a drop of glue. When this medium takes the form of a booklet, it is observed that the known folding methods used for its preparation produce the aforementioned disadvantages. If the medium takes the form of a single sheet, its small format means that the area available for information is very limited.

### 3. PRESENTATION OF THE INVENTION

The method of producing the booklet according to the invention aims to overcome these disadvantages. Advantageously, it provides the writer of the information with a generous printing area which can evolve according to requirements as a function of the number of sheets employed in the preparation of the booklet. Moreover, it provides the user with a book that is easy to handle and to read, and whose sheets remain secured to the central fold after opening.

The method of producing the booklet is characterised in that several sheets of paper of identical material, of the same thickness and the same format, are stacked on top of one another and then are interconnected using a seam of glue which is applied transversally along the centre thereof, and then the said stacked sheets are folded at the steam of glue which forms the central hinge around which the symmetrical sheets are articulated, each having a folding line at its centre, thus defining an end panel and a central panel, and the inner faces of all the stacked end panels are then folded simultaneously against the inner faces of all the stacked central panels, articulated around the central hinge by a fold type known as a “wallet” fold, so that the inner faces of the end panels are then pressed against the inner faces of the central panels which themselves are articulated around the central hinge, and then the inner faces of the booklet are applied against one another, two faces of them having first received a line or several drops of temporary glue on the edges or other appropriate places, so as to hold the booklet closed.

The successive folding operations have the effect of increasing the useful surface space on the booklet in relation to its outer surface area, as the number of identical sheets initially stacked and attached together grows. By stacking the said sheets, the device according to the invention generates a multiplying effect on the printing area of the paper sheets joined together by the central hinge, without the increase of the visible surface area of the closed booklet.

Thus, a booklet composed of two identical sheets which are stacked, glued and folded in accordance with the invention will have 16 inner and outer faces capable of receiving printed information. If this booklet is composed of 5 stacked sheets, it will then have 40 faces, and so on, with no change to its outer dimensions after closure.

If the booklet created needs to have at least two identical sheets, the device according to the invention allows the booklet to be composed of some ten stacked sheets before the described gluing and folding operations.

It should be noted that the method of producing the booklet described above provides that each of the sheets of the booklet have only two panels.

The method can also be applied when each of the sheets have two folding lines dividing each sheet into three panels of the same size. In this case, it is best to perform a double folding operation of the “wallet” type, by folding the end panels onto the intermediate panels in a first stage, so as to confer on the sheets of the booklet the same configuration as the one specified in the above description, before performing a second “wallet” fold and finally applying the glue to hold the booklet closed.

According to a preferred embodiment of the method subject of the invention, the latter consists of creating a booklet that includes detachable end panels to be used as reply coupons or discount vouchers.

The folding line of each sheet at its centre can be emphasised or not by the perforation of the paper, thus dividing the end panel from the central panel and so facilitating the detachment of the end panel after the booklet is unfolded by the user.

In a booklet produced according to the method constituting the invention, the stacking of the sheets glued and joined together at the central hinge, allows the number of end panels that can be used as reply coupons or discount vouchers to be increased.

The detachment of any of these coupons has no effect on the cohesion of the booklet, which remains easy to read, through the retention of its central panels which can act as stubs or counterfoils.

### 4. BRIEF DESCRIPTION OF THE DRAWINGS

The appended drawings illustrate the invention:

FIG. 1 is a perspective view of five stacked sheets constituting a booklet before gluing at the central fold.

FIG. 2 shows the same sheets interconnected after gluing.

FIGS. 3 and 4 show the “wallet” type folding method of the sheets of the booklet before closure by drops of glue.

FIG. 5 shows the booklet opened and unfolded, after detachment of the end panels used as coupons or vouchers.

### 5. EMBODIMENT OF THE INVENTION

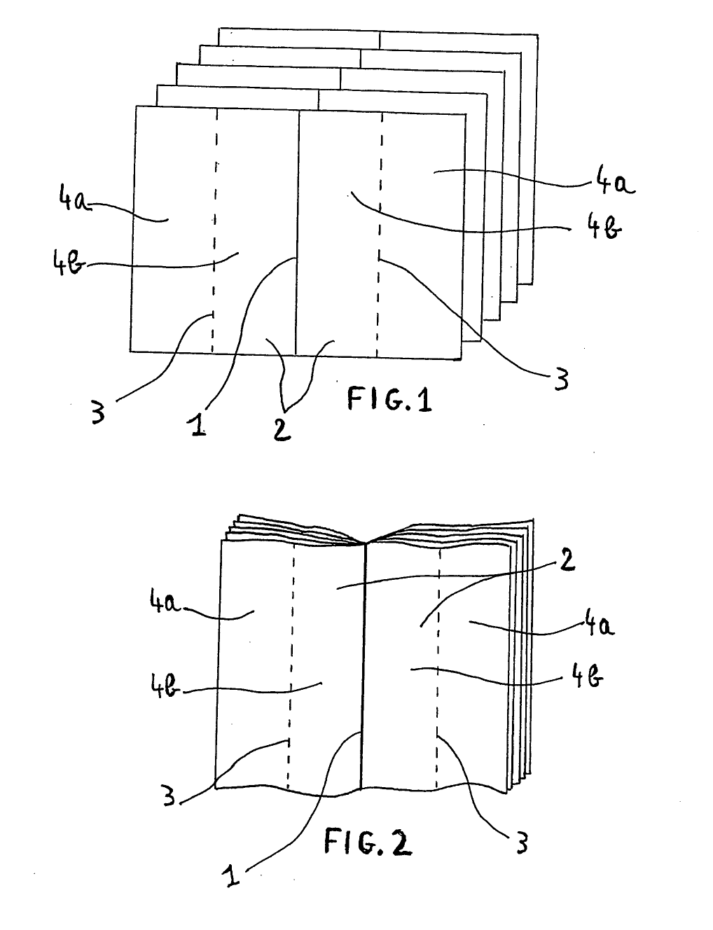

With reference to the abovementioned drawings, sheets of paper of the same format are stacked (FIG. 1) on top of one another and then interconnected transversally at their centre by a seam of glue (FIG. 2) to constitute the central hinge (1). Around this central hinge (1) the symmetrical sheets (2) are articulated, each having a folding line (3) at its centre, defining an end panel (4a) and a central panel (4b).

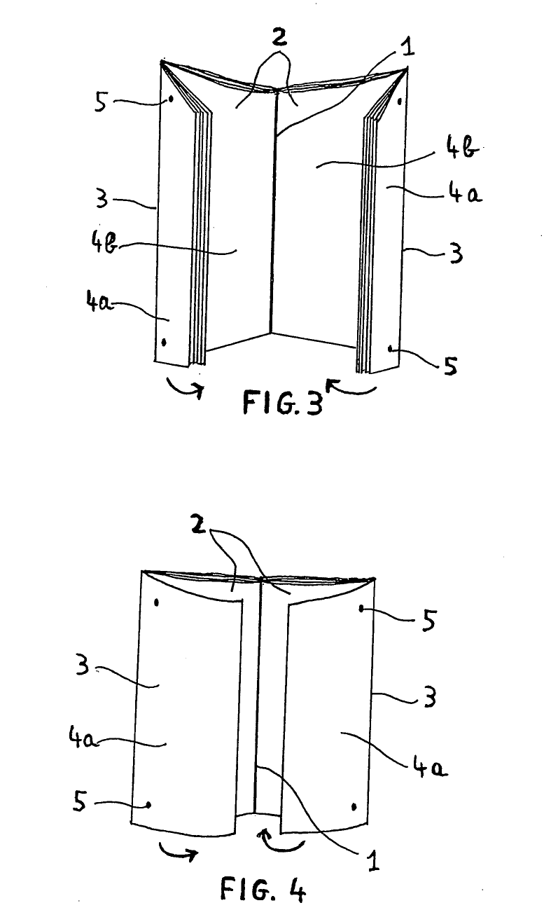

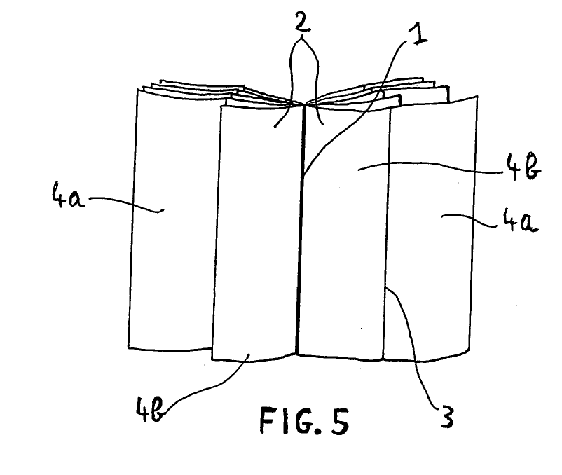

The successive stages of “wallet” type folding preceding the closure of the booklet are shown in FIGS. 3 and 4.

FIG. 3 shows the sheets being folded around the folding line (3) on the inner faces of all the stacked panels located at the ends (4a) of the sheets (2), all folded simultaneously against the inner faces of all the stacked central panels (4b) which are articulated around the central hinge (1). After this folding operation, as illustrated in FIG. 4, the inner faces of the end panels (4a) are pressed against the inner faces of the central panels (4b).

Closure of the booklet is then achieved by closing the inner faces of the booklet onto each other, two faces of the booklet having received, before the closure, lines or drops of glue (5) on the edges or in other appropriate places. The cover of the booklet folded and closed, is thus composed of the outer central panels (4b) of the sheet located underneath the other stacked sheets before the folding operation.

After opening and unfolding, the booklet remains homogeneous, keeping its sheets (2) attached to the central hinge (1) even if the user has detached one or more end panels (4a). FIG. 5 thus illustrates a booklet that is opened and unfolded from which a right inner end panel (4a) and a left outer end panel (4a) have been detached.

### 6. ADVANTAGES AND INDUSTRIAL APPLICATION OF THE INVENTION

It should be noted that during the unfolding of the booklet achieved by separating the inner faces of the sheets, the user immediately has access to a great deal of information without the unfolding leading to a handling problem made even more difficult by the number of sheets (2) carrying the information, since each sheet remains attached to the others by the central hinge (1).

Furthermore, the booklet, used as an information source intended to accompany, in its packaging or case, any product, whether foodstuffs or not, or any appliance, is not unfolded when this product or appliance is unpacked or removed from its case, since the folding and gluing operations prevent any inopportune opening of the booklet at this point.

To this advantage which benefits the user of the booklet, is added another advantage present in the industrial domain, that is the final closure by gluing, which makes the booklet easy to handle without the risk of inopportune opening. Thus, this ease of handling, after the application of a drop of glue on one of the faces of the closed booklet, allows the laying in automatic mode on any type of support with which the booklet may be associated, such as packing cartons, plastic bags, cans in the case of food products, newspapers or information magazines, and so on—the list being not limited.

Apart from the above, by a final cutting-out operation, it is possible to confer to the closed booklet, made up in accordance with the invention, the shape of the product or of the appliance for which it is intended, such as a perfume bottle, a mobile phone, etc. Cutting-out does not affect the methods of gluing and folding effected beforehand as long as it does not totally remove the central hinge (1) which is holding together the stacked sheets at their centre, and the folding line (3) of the symmetrical sheets (2) separating the end panels (4a) and the central panels (4b).

1- A method of producing a booklet which is glued at the central fold thereof folded and closed, characterised in that several sheets of paper of identical material, of the same thickness and of the same format, are stacked on top of one another, interconnected using a steam of glue applied transversally at their centre, and then the said stacked sheets are folded together at the steam of glue, which constitutes the central hinge (1) around which the symmetrical sheets (2) are articulated, each having a folding line (3) at its centre thereby defining an end panel (4a) and a central panel (4b), and then the inner faces of all the stacked end panels (4a) are synchronously folded against the inner faces of all the stacked central panels (4b) which themselves are articulated around the central hinge (1), by means of a second fold called a “wallet” fold, the inner faces of the end panels (4a) then being pressed against the inner faces of the central panels (4b) articulated around the central hinge (1), and finally the inner faces of the booklet are applied against one another to achieve closure of the booklet, two faces of them having received a line or some drops of temporary glue on the edges or other appropriate places.

2- A method of producing a booklet according to claim 1, characterised in that the cover of the folded and closed booklet is composed of the outer central panels (4b) of the sheet located underneath the other stacked sheets before the folding operation.

3- A method of producing a booklet according to claim 1, characterised in that the folding line (3) of each sheet (2) at its centre can be perforated in order to facilitate the detachment of the end panel (4a) after unfolding of the booklet.

4- A method of producing a booklet according to claims 1 and 3, characterised in that the detachment of one or more end panels (4a) of any sheet, regardless of its position in the booklet, does not affect the cohesion of the booklet, glued at the central fold, which retains its central panels (4b).

5- A method of producing a booklet according to claims 1 to 4, characterised in that a appropriate cutting-out of the closed booklet can enable it to take on the shape of the medium for which it is intended, retaining its cohesion when at least some part of the central hinge (1) and of the folding line (3) of the symmetrical sheets (2) are not removed by such a cutting-out operation.
